(19) United States
(12) Patent Application Publication
(10) Pub. No.: US 2011/0047199 A1
(43) Pub. Date: Feb. 24, 2011

(54) CORRELATION APPARATUS AND METHOD FOR ACQUIRING ROBUST SYNCHRONIZATION

(75) Inventors: Pansoo Kim, Daejeon (KR); Dae Ig Chang, Daejeon (KR); Wonjin Sung, Seoul (KR); Sangtae Kim, Seoul (KR); Dong-Uk Lee, Seoul (KR)

Correspondence Address: RABIN & Berdo, PC, 1101 14TH STREET, NW, SUITE 500, WASHINGTON, DC, 20005, US

(73) Assignees: ELECTRONICS AND TELECOMMUNICATIONS RESEARCH INSTITUTE, Daejeon (KR); INDUSTRY-UNIVERSITY COOPERATION FOUNDATION SOGANG UNIVERSITY, Seoul (KR)

(21) Appl. No.: 12/507,012

(22) Filed: Jul. 21, 2009

(30) Foreign Application Priority Data
Nov. 18, 2008 (KR) 10-2008-0114739

(51) Int. Cl. G06F 17/15

(52) U.S. Cl. 708/422

(57) ABSTRACT

Provided is a correlation apparatus and method for acquiring a robust synchronization. The correlation method may include: calculating a received symbol phase difference with respect to a received symbol; calculating a correlation SoF symbol phase difference with respect to a correlation SoF symbol for a correlation; calculating a differential correlation value of the received symbol using the received symbol phase difference and the correlation SoF symbol phase difference; calculating a Euclidean distance value of the received symbol using the received symbol phase difference; and calculating a sum correlation value of the received symbol using the differential correlation value and the Euclidean distance value.

### BACKGROUND

1. Field of the Invention

The present invention relates to a correlation apparatus and method for acquiring a robust synchronization, and more particularly, a correlation apparatus and method that may acquire a robust synchronization using a magnitude sum correlation method and a vector sum correlation method.

2. Description of the Related Art

A correlation apparatus may calculate a correlation value with respect to a received symbol. The calculated correlation value may be used as basic data for an initial frame synchronization process.

For example, a correlation value that is calculated by the correlation apparatus may be used as basic data for an initial frame synchronization process of a satellite broadcasting system.

With a current trend where broadcasting and communication is being united, the satellite broadcasting system may be appropriate for interactive services such as the Internet, multimedia contents, and the like. In the satellite broadcasting system, it is required to secure a high transmission capacity in a signal power and a transmission bandwidth of a satellite repeater, in order to stably provide new services such as a large multimedia communication and the like. In particular, a Digital Video Broadcasting Satellite Version 2 (DVB-S2) system may operate in an environment where a relatively great frequency error of ±20% with respect to a bandwidth occurs and a signal-to-noise ratio (SNR) is lowest −2.35 dB. Accordingly, as the initial frame synchronization process capable of enhancing the relatively great frequency error and the low SNR is required for a carrier recovery in a reception end, there is a need for a correlation apparatus and method that may calculate a reliable correlation value.

When performing a frame synchronization a coherent correlation method of calculating a correlation value using a received symbol column and a Start of Frame (SoF) symbol column is generally used. The SoF symbol column may correspond to a preamble.

In the coherent correlation method, the correlation value may be given by,

$${X}_{coh} = \vert {\sum }_{k = 0}^{N - 1} {r}_{k} {d}_{k}^{*} \vert . \qquad [ Equation 1 ]$$

Here, rₖ denotes the received symbol column, and may be given by the following Equation 2. dₖ denotes the SoF symbol column for a correlation in the reception end. N denotes a number of SoF symbols. Equation 2 may be expressed by,

$${r}_{k} = {s}_{k} + {n}_{k} , k = 0 , … , N - 1 \qquad [ Equation 2 ]$$

Here, sₖ denotes a transmitted symbol column, and nₖ denotes an additive white Gaussian noise (AWGN) sample.

However, in the case of the above method, a serious performance deterioration may occur in the environment where the relatively great frequency error occurs. Accordingly, proposed is a differential correlation method that may enhance the performance deterioration, caused by the frequency error, using a phase difference between neighboring symbols.

In the differential correlation method, the correlation value may be given by,

$${X}_{duff} = \vert {\sum }_{k = 1}^{N - 1} {r}_{k}^{*} {r}_{k - 1} {d}_{k} {d}_{k - 1}^{*} \vert . \qquad [ Equation 3 ]$$

The differential correlation method is a simple method that may enhance the frequency error. Proposed is a differential-generalized post detection integration (D-GPDI) method by extending the differential correlation method.

In the D-GPDI method, the correlation value may be given by,

$${X}_{D \text{-} GPDI} = {\sum }_{i = 1}^{N - 1} \vert {\sum }_{k = i}^{N - 1} {r}_{k}^{*} {r}_{k - i} {d}_{k} {d}_{k - i}^{*} \vert . \qquad [ Eqaution 4 ]$$

In comparison to the differential correlation method of the above Equation 3, the D-GPDI method may increase a complexity, whereas the D-GPDI method may use more differential information and thus may have an enhanced frame synchronization.

Also, proposed is a GPDI method where a synchronization correlation method and the D-GPDI method are integrated.

In the GPDI method, the correlation value may be given by,

$${X}_{GPDI} = {\sum }_{k = 0}^{N - 1} {\vert {r}_{k} {d}_{k}^{*} \vert}^{2} + 2 {\sum }_{i = 1}^{N - 1} \vert {\sum }_{k = i}^{N - 1} {r}_{k}^{*} {r}_{k - i} {d}_{k} {d}_{k - i}^{*} \vert . \qquad [ Equation 5 ]$$

Also, Choi and Lee's Detector (CLD)-1 and CLD method induced using a maximum-likelihood (ML) method are proposed.

In the CLD-1, the correlation value may be given by,

$$CLD \text{-} 1 \text{:} {X}_{CLD - 1} = {\sum }_{i = 1}^{N - 1} \{ {\vert {\sum }_{k = i}^{N - 1} {r}_{k}^{*} {r}_{k - i} {d}_{k} {d}_{k - i}^{*} \vert}^{2} - {\sum }_{k = i}^{N - 1} {\vert {r}_{k} \vert}^{2} {\vert {r}_{k - i} \vert}^{2} \} . \qquad [ Equation 6 ]$$

In the CLD-2 scheme, the correlation value may be given by,

$$CLD \text{-} 2 \text{:} {X}_{CLD - 2} = {\sum }_{i = 1}^{N - 1} \{ \vert {\sum }_{k = i}^{N - 1} {r}_{k}^{*} {r}_{k - i} {d}_{k} {d}_{k - i}^{*} \vert - {\sum }_{k = i}^{N - 1} \vert {r}_{k} \vert \vert {r}_{k - i} \vert \} . \qquad [ Equation 7 ]$$

The CLD-2 corresponds to a method where a square component is removed in the CLD-1. The CLD-1 may have a relatively excellent performance in a low SNR whereas the CLD-2 may have a relatively excellent performance in a high SNR.

Accordingly, with respect to a case where a frequency error is great and a case where the frequency error is small in a low SNR, there is a need for a correlation method that may have a further enhanced performance than the aforementioned methods.

### SUMMARY

An aspect of the present invention provides a correlation apparatus and method for acquiring a robust synchronization that may have a further enhanced synchronization performance by adopting a vector sum correlation method and a magnitude sum correlation method using a Euclidean distance value with respect to a received symbol.

The present invention is not limited to the above purposes and other purposes not described herein will be apparent to those of skill in the art from the following description.

According to an aspect of the present invention, there is provided a correlation apparatus for acquiring a robust synchronization, the correlation apparatus including: a received symbol phase difference calculation unit to calculate a received symbol phase difference between a received symbol and a delay received symbol of delaying the received symbol; a correlation Start of frame (SoF) symbol phase difference calculation unit to calculate a correlation SoF symbol phase difference between a correlation SoF symbol for a correlation and a delay correlation SoF symbol of delaying the correlation SoF symbol; a differential correlation unit to calculate a differential correlation value of the received symbol using the received symbol phase difference and the correlation SoF symbol phase difference; a Euclidean distance calculation unit to calculate a Euclidean distance value of the received symbol using the received symbol phase difference; and a sum correlation unit to calculate a sum correlation value of the received symbol using the differential correlation value and the Euclidean distance value.

According to another aspect of the present invention, there is provided a correlation method for acquiring a robust synchronization, the correlation method including: calculating a received symbol phase difference with respect to a received symbol; calculating a correlation SoF symbol phase difference with respect to a correlation SoF symbol for a correlation; calculating a differential correlation value of the received symbol using the received symbol phase difference and the correlation SoF symbol phase difference; calculating a Euclidean distance value of the received symbol using the received symbol phase difference; and calculating a sum correlation value of the received symbol using the differential correlation value and the Euclidean distance value.

According to embodiments of the present invention, there may be provided a correlation apparatus and method for acquiring a robust synchronization that may enhance a frequency error by adopting a vector sum correlation method and a magnitude sum correlation method using a Euclidean distance value with respect to a received value, and may also enhance a synchronization performance.

### BRIEF DESCRIPTION OF THE DRAWINGS

FIG. 1 is a diagram illustrating a general frame structure of a physical layer in a Digital Video Broadcasting Satellite Version 2 (DVB-S2) system;

FIG. 2 is a block diagram illustrating a configuration of a correlation apparatus for acquiring a robust synchronization according to an embodiment of the present invention;

FIG. 3 is a block diagram illustrating a configuration of a correlation apparatus for acquiring a robust synchronization according to another embodiment of the present invention;

FIG. 4 is a flowchart illustrating a correlation method for acquiring a robust synchronization according to an embodiment of the present invention;

FIG. 5 is a flowchart illustrating a method of detecting a frame start point using a correlation method for acquiring a robust synchronization according to an embodiment of the present invention;

FIG. 6 is a flowchart illustrating a method of detecting a frame start point using a correlation method for acquiring a robust synchronization according to another embodiment of the present invention;

FIGS. 7 and 8 are graphs illustrating a synchronization performance comparison between CLD-1 and CLD-2 with a most excellent synchronization performance in the convention art, and a vector sum correlation method and a magnitude sum correlation method according to an embodiment of the present invention;

FIG. 9 is a graph illustrating a synchronization performance comparison for each correlation method based on an SNR using a constant false alarm rate (CFAR) according to an embodiment of the present invention; and

FIG. 10 is a graph illustrating a synchronization performance comparison based on a change of fₘₐₓ in −2.35 dB SNR and 5 dB SNR according to an embodiment of the present invention.

### DETAILED DESCRIPTION

Hereinafter, a correlation apparatus and method for acquiring a robust synchronization according to an embodiment of the present invention will be described in detail with reference to the accompanying drawings.

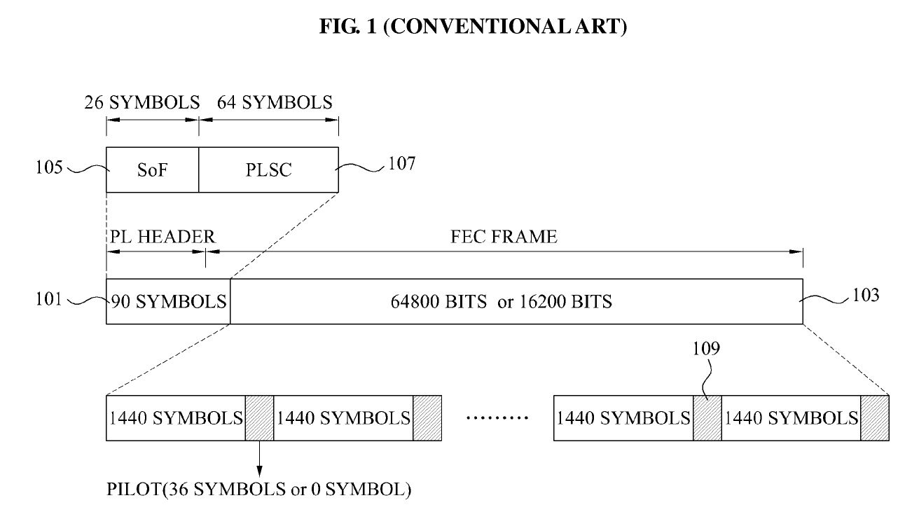

FIG. 1 is a diagram illustrating a structure of a general frame of a physical layer of a Digital Video Broadcasting Satellite Version 2 (DVB-S2) system.

Referring to FIG. 1, the general frame of the physical layer of the DVB-S2 system may include a physical layer (PL) header 101 and a forward error correction (FEC) frame 103.

The PL header 101 may include a Start of Frame (SoF) 105 of 26 symbols and a physical layer signaling code (PLSC) 107 of 64 symbols. The PLSC 107 may encode information associated with a modulation scheme, a coding rate, whether a pilot symbol 109 is inserted into the FEC frame 103, and the like.

The frame may be constructed into 16 frame structures according to the modulation scheme, for example, a quadrature phase shift keying (QPSK) scheme, an 8PSK scheme, a 16 amplitude and phase shift keying (16APSK) scheme, and a 32APSK scheme, a data length of the FEC frame 103, for example, 64800 bits/frame and 16200 bits/frame, and whether the pilot symbol 109 is inserted into the FEC frame 103.

A correlation method for acquiring a robust synchronization according to an embodiment of the present invention may include a magnitude sum correlation method and a vector sum correlation method.

The magnitude sum correlation method may be generated by modifying a second term of Choi and Lee's Detector (CLD)-2 and may be expressed by,

$${X}_{M} = {\sum }_{i = 1}^{N - 1} \{ \vert {\sum }_{k = i}^{N - 1} {r}_{k}^{*} {r}_{k - i} {d}_{k} {d}_{k - i}^{*} \vert - \sqrt{{\sum }_{k = i}^{N - 1} {\vert {r}_{k} \vert}^{2} {\vert {r}_{k - i} \vert}^{2}} \} . \qquad [ Equation 8 ]$$

Here, the second term denotes a (N−1) dimensional Euclidean distance with respect to a first term of a parenthesis.

The vector sum correlation method may be generated by modifying the above Equation 8 of the magnitude sum correlation method using a complex sum correlation method, and may be expressed by,

$${X}_{V} = \vert {\sum }_{i = 1}^{D} {\sum }_{k = i}^{N - 1} {r}_{k}^{*} {r}_{k - i} {d}_{k} {d}_{k - i}^{*} \vert - \sqrt{{\sum }_{i = 1}^{D} {\sum }_{k = i}^{N - 1} {\vert {r}_{k} \vert}^{2} {\vert {r}_{k - i} \vert}^{2}} . \qquad [ Equation 9 ]$$

Here, Δf denotes a frequency error, T denotes a symbol time slot, and D denotes a distance between symbols. Also, D≦N−1, and D indicates a maximum natural number that satisfies |Δf·T·D|<0.5.

For example, when a bandwidth-to-frequency error |Δf·T|=0, D=25 may be applied. When |Δf·T|=0.2, D=2 may be applied.

In the vector sum correlation method, the second term denotes a D·(N−1) dimensional Euclidean distance.

In the magnitude sum correlation method, the (N−1) dimensional Euclidean distance is obtained by adding up a magnitude, that is, a scalar value with respect to a Euclidean distance of each vector in maximum (N−1) dimensions. In the vector sum correlation method, the D·(N−1) dimensional Euclidean distance is obtained by calculating a Euclidean distance with respect to a vector sum in maximum D·(N−1) dimensions.

The vector sum correlation method uses the complex sum correlation method to calculate the correlation value. Accordingly, when the frequency error is small, the vector sum correlation method may be relatively excellent in comparison to the magnitude sum correlation method.

As described above, the correlation method for acquiring the robust synchronization according to an embodiment of the present invention, that is, the magnitude sum correlation method and the vector sum correlation method may have a further enhanced synchronization performance than CLD-1 and CLD-2 having an excellent synchronization performance in an environment where the frequency error exists.

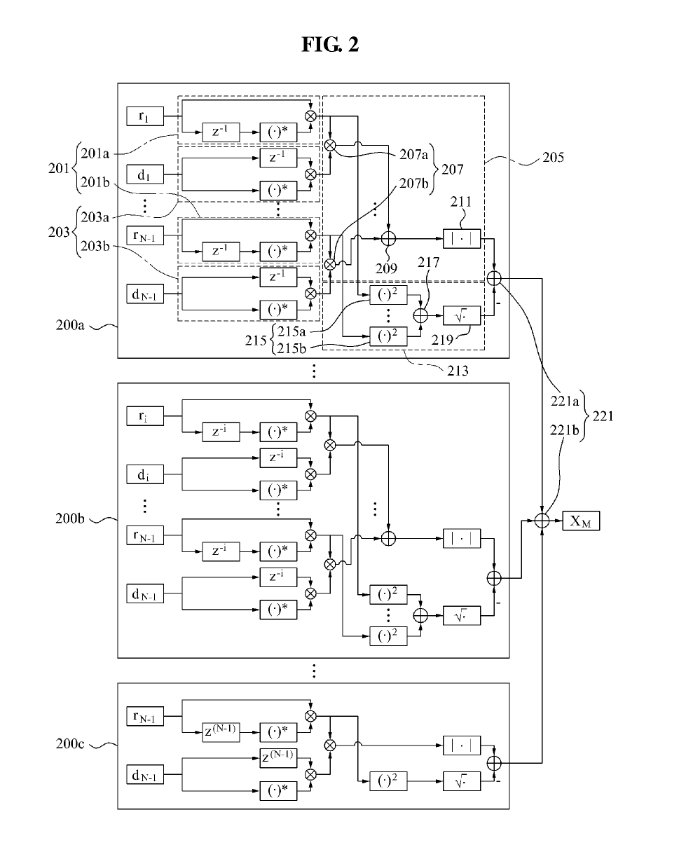

FIG. 2 is a block diagram illustrating a configuration of a correlation apparatus for acquiring a robust synchronization according to an embodiment of the present invention.

Referring to FIG. 2, when N symbols are received, the correlation apparatus may include a first sub-correlation unit 200a, a second sub-correlation unit 200b, and an (N−1)'^{th} sub-correlation unit 200c. The first sub-correlation unit 200a may calculate a first magnitude sum correlation value with respect to first through (N−1)^{th} received symbols. The second sub-correlation unit 200b may calculate a second magnitude sum correlation value with respect to second through (N−1)^{th} received symbols. The (N−1)^{th} sub-correlation unit 200c may calculate an (N−1)^{th} magnitude sum correlation value with respect to the (N−1)^{th} received symbol.

The first sub-correlation unit 200a may include a received symbol phase difference calculation unit 201, a correlation SoF symbol phase difference calculation unit 203, a differential correlation unit 205, a Euclidean distance calculation unit 213, and a sum correlation unit 221.

The received symbol phase difference calculation unit 201 may calculate a received symbol phase difference between a received symbol and a delay received symbol of delaying the received symbol.

Specifically, the received symbol phase difference calculation unit 201 may include a first received symbol phase difference calculation unit 201a to calculate a first received symbol phase difference between a first received symbol and a first delay received symbol of delaying the first received symbol by a predetermined interval, and a second received symbol phase difference calculation unit 201b to calculate a second received symbol phase difference between a second received symbol and a second delay received symbol of delaying the second received symbol by the predetermined interval.

The first received symbol phase difference calculation unit 201a may calculate the first received symbol phase difference by multiplying the first received symbol and a first received complex conjugate with respect to the first delay received symbol. The second received symbol phase difference calculation unit 201b may calculate the second received symbol phase difference by multiplying the second received symbol and a second received complex conjugate with respect to the second delay received symbol.

The correlation SoF symbol phase difference calculation unit 203 may calculate a correlation SoF symbol phase difference between a correlation SoF symbol for a correlation and a delay correlation SoF symbol of delaying the correlation SoF symbol.

Specifically, the correlation SoF symbol phase difference calculation unit 203 may include a first correlation SoF symbol phase difference calculation unit 203a to calculate a first correlation SoF symbol phase difference between a first correlation SoF symbol and a first delay correlation SoF symbol of delaying the first correlation SoF symbol by a predetermined interval, and a second correlation SoF symbol phase difference calculation unit 203b to calculate a second correlation SoF symbol phase difference between a second correlation SoF symbol and a second delay correlation SoF symbol of delaying the second correlation SoF symbol by the predetermined interval.

Here, the first correlation SoF symbol phase difference calculation unit 203a may calculate the first correlation SoF symbol phase difference by multiplying the first delay correlation SoF symbol and a first correlation complex conjugate with respect to the first correlation SoF symbol. The second correlation SoF symbol phase difference calculation unit 203b may calculate the second correlation SoF symbol phase difference by multiplying the second delay correlation SoF symbol and a second correlation complex conjugate with respect to the second correlation SoF symbol.

The differential correlation unit 205 may calculate a differential correlation value of the received symbol using the received symbol phase difference and the correlation SoF symbol phase difference.

Specifically, the differential correlation unit 205 may include a multiplication unit 207, a summation unit 209, and an absolute value processing unit 211.

The multiplication unit 207 may include a first multiplication unit 207a to output a first phase difference multiplication value by multiplying the first received symbol phase difference and the first correlation SoF symbol phase difference, and a second multiplication unit 207b to output a second phase difference multiplication value by multiplying the second received symbol phase difference and the second correlation SoF symbol phase difference.

The summation unit 209 may output a sum of phase difference multiplication values by adding up the first phase difference multiplication value and the second phase difference multiplication value.

The absolute value processing unit 211 may output the differential correlation value by calculating an absolute value with respect to the sum of phase difference multiplication values.

The Euclidean distance calculation unit 213 may calculate a Euclidean distance value of the received symbol using the received symbol phase difference.

Specifically, the Euclidean distance calculation unit 213 may include a squaring unit 215, a summation unit 217, and a square root processing unit 219.

The squaring unit 215 may include a first squaring unit 215a to output a first square value by squaring the first received symbol phase difference, and a second squaring unit 215b to output a second square value by squaring the second received symbol phase difference.

The summation unit 217 may output a sum of square values by adding up the first square value and the second square value.

The square root processing unit 219 may output the Euclidean distance value between the first received symbol and the second received symbol by calculating a square root with respect to the sum of square values.

The sum correlation unit 221 may include a correlation first summation unit 221a and a correlation second summation unit 221b.

The correlation first summation unit 221a may calculate a first magnitude sum correlation value using the differential correlation value and the Euclidean distance value. Specifically, the correlation first summation unit 221a may calculate the first magnitude sum correlation value using a distance between the differential correlation value and the Euclidean distance value.

The correlation second summation unit 221b may calculate a magnitude sum correlation value by adding up the first magnitude sum correlation value, the second magnitude sum correlation value, and an (N−1)^{th} magnitude sum correlation value.

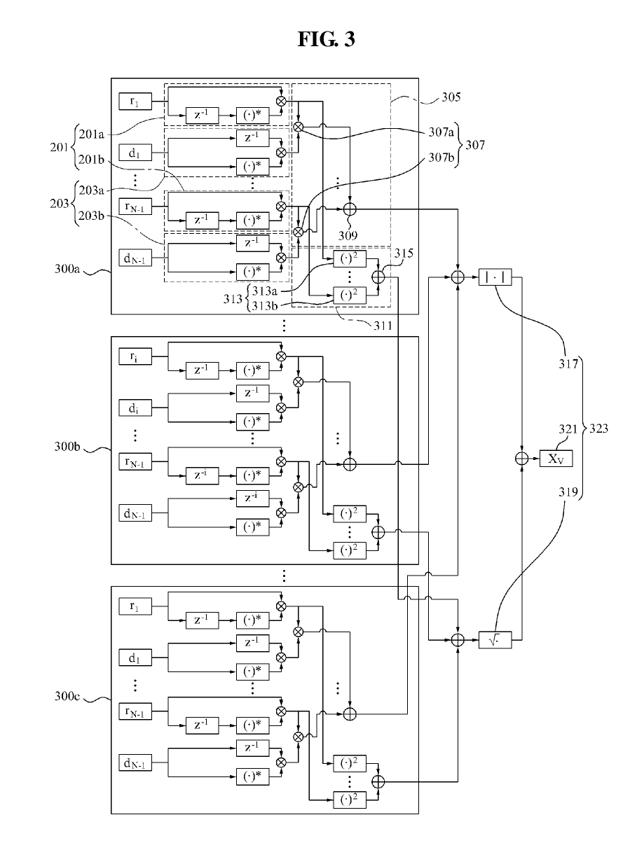

FIG. 3 is a block diagram illustrating a configuration of a correlation apparatus for acquiring a robust synchronization according to another embodiment of the present invention.

The structure of the correlation apparatus of FIG. 3 is the same as the structure of the correlation apparatus described above with reference to FIG. 2, and thus further detailed description related thereto will be omitted here.

The correlation apparatus according to the present embodiment may include sub-correlation units as many as a number corresponding to D of the above Equation 9.

A differential correlation unit 305 of each of the sub-correlation units may include only a multiplication unit 307 and a summation unit 309. A Euclidean distance calculation unit 311 may include a squaring unit 313 and a summation unit 315.

A sum correlation unit 323 may include an absolute value processing unit 317, a square root processing unit 319, and a summation unit 321.

The absolute value processing unit 317 may calculate an absolute value with respect to a summation value of a first differential correlation value of a first sub-correlation unit 300a, a second differential correlation value of a second sub-correlation unit 300b, and a (D−1)^{th} differential correlation value of a (D−1)'^{th} sub-correlation unit 300c.

The square root processing unit 319 may calculate a square root with respect to a summation value of a first Euclidean distance value of the first sub-correlation unit 300a, a second Euclidean distance value of the second sub-correlation unit 300b, and a (D−1)'^{th} Euclidean distance value of a (D−1)'^{th} sub-correlation unit 300c.

The summation unit 321 may calculate a vector sum correlation value using an output signal of the absolute value processing unit 317 and an output signal of the square root processing unit 319. Specifically, the summation unit 321 may calculate the vector sum correlation value using a difference between the output signal of absolute value processing unit 317 and the output signal of the square root processing unit 319.

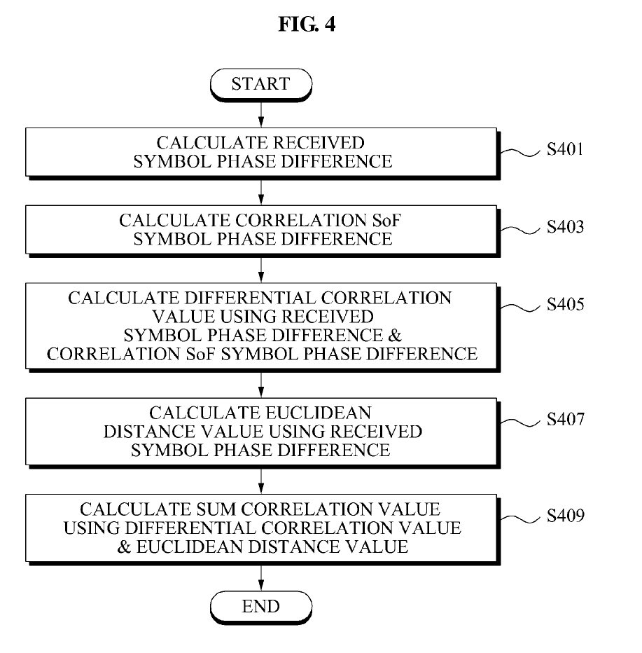

FIG. 4 is a flowchart illustrating a correlation method for acquiring a robust synchronization according to an embodiment of the present invention.

In operation S401, a correlation apparatus for acquiring the robust synchronization may calculate a received symbol phase difference with respect to a received symbol

Specifically, the correlation apparatus may calculate a first received symbol phase difference between a first received symbol and a first delay received symbol of delaying the first received symbol by a predetermined interval, and may calculate a second received symbol phase difference between a second received symbol and a second delay received symbol of delaying the second received symbol by the predetermined interval.

In operation S403, the correlation apparatus may calculate a correlation SoF symbol phase difference with respect to a correlation SoF symbol.

Specifically, the correlation apparatus may calculate a first correlation SoF symbol phase difference between a first correlation SoF symbol and a first delay correlation SoF symbol of delaying the first correlation SoF symbol by a predetermined interval, and may calculate a second correlation SoF symbol phase difference between a second correlation SoF symbol and a second delay correlation SoF symbol of delaying the second correlation SoF symbol by the predetermined interval.

In operation S405, the correlation apparatus may calculate a differential correlation value of the received symbol using the received symbol phase difference and the correlation SoF symbol phase difference.

Specifically, the correlation apparatus may calculate the differential correlation value of the received symbol using the first and second received symbol phase differences, and the first and second correlation SoF symbol phase differences.

More specifically, the correlation apparatus may output a first phase difference multiplication value by multiplying the first received symbol phase difference and the first correlation SoF symbol phase difference, and may output a second phase difference multiplication value by multiplying the second received symbol phase difference and the second correlation SoF symbol phase difference. Next, the correlation apparatus may output a sum of phase difference multiplication values by adding up the first phase difference multiplication value and the second phase difference multiplication value and then output the differential correlation value by calculating an absolute value with respect to the sum of phase difference multiplication values.

In operation S407, the correlation apparatus may calculate a Euclidean distance value of the received symbol using the received symbol phase difference.

Specifically, the correlation apparatus may calculate the Euclidean distance value of the received symbol using the first and second received symbol phase differences.

More specifically, the correlation apparatus may output a first square value by squaring the first received symbol phase difference, and a second square value by squaring the second received symbol phase difference, may output a sum of square values by adding the first square value and the second square value, and then output the Euclidean distance value between the first received symbol and the second received symbol by calculating a square root with respect to the sum of square values.

In operation S409, the correlation apparatus may calculate a sum correlation value using the differential correlation value and the Euclidean distance value.

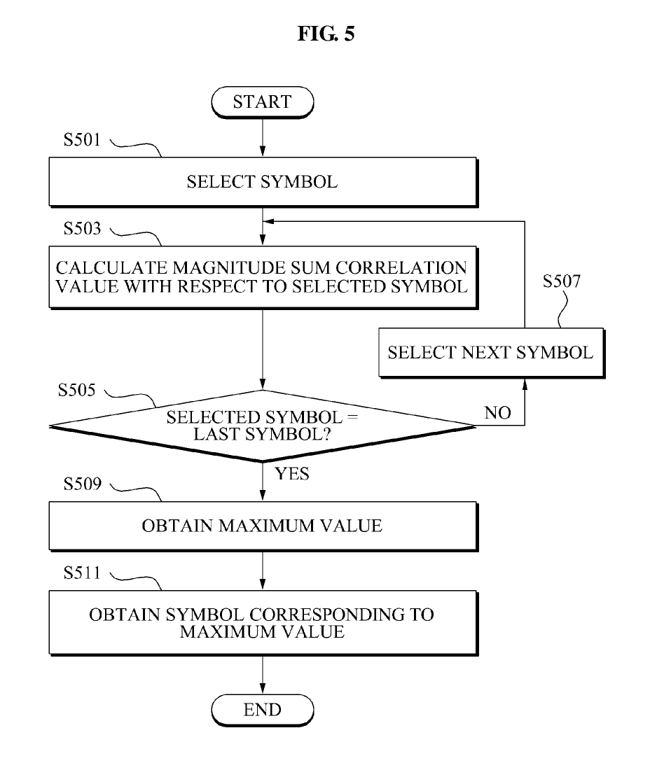

FIG. 5 is a flowchart illustrating a method of detecting a frame start point using a correlation method for acquiring a robust synchronization according to an embodiment of the present invention.

Referring to FIG. 5, a correlation apparatus for acquiring the robust synchronization may select a symbol, from a first symbol, from a received symbol column, that is, in a received frame in operation S501.

In operation S503, the correlation apparatus may calculate a magnitude sum correlation value with respect to the selected symbol, using a magnitude sum correlation method.

Specifically, the correlation apparatus may calculate the magnitude sum correlation value using the correlation method of the above Equation 8 with respect to the selected first symbol where a symbol index u=0.

I In operation S505, the correlation apparatus may determine whether a symbol used to calculate the magnitude sum correlation value is a last symbol.

Specifically, when the symbol used to calculate the magnitude sum correlation value is the last symbol where u=L−1, the correlation apparatus may obtain a maximum value of magnitude sum correlation values with respect to each symbol and detect a symbol corresponding to the maximum value in operations S509 and S511. Here, the detected symbol may be used as the frame start point.

Conversely, when the symbol used to calculate the magnitude sum correlation value is not the last symbol, the correlation apparatus may repeat operations S507 and S503 of selecting a next symbol and calculating a magnitude sum correlation value with respect to the selected symbol.

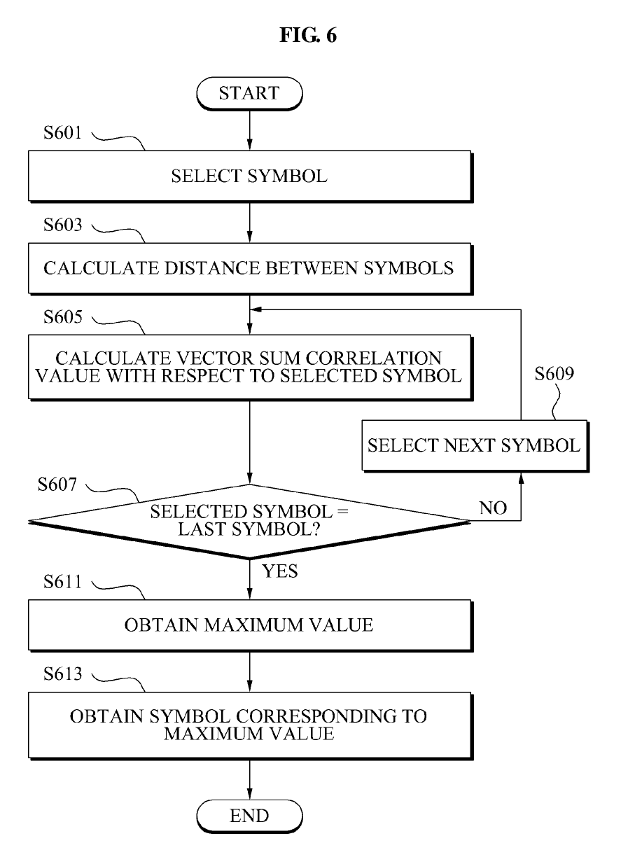

FIG. 6 is a flowchart illustrating a method of detecting a frame start point using a correlation method for acquiring a robust synchronization according to another embodiment of the present invention.

Referring to FIG. 6, a correlation apparatus for acquiring the robust synchronization may select a symbol, from a first symbol, from a received symbol column, that is, in a received frame in operation S601.

In operation S603, the correlation apparatus may calculate a distance D between symbols of the above Equation 9. D denotes an integer.

Here, D≦N−1, and D corresponds to a maximum natural number that satisfies |Δf·T·D|<0.5.

In operation S605, the correlation apparatus may calculate a vector sum correlation value with respect to the selected symbol, using a vector sum correlation method.

Specifically, the correlation apparatus may calculate the vector sum correlation value using the correlation method of the above Equation 9 with respect to the first symbol where a symbol index u=0.

I In operation S607, the correlation apparatus may determine whether a symbol used to calculate the vector sum correlation value is a last symbol.

Specifically, when the symbol used to calculate the vector sum correlation value is the last symbol where u=L−1, the correlation apparatus may obtain a maximum value of vector sum correlation values with respect to each symbol and detect a symbol corresponding to the maximum value in operation S611 and S613. Here, the detected symbol may be used as the frame start point. Conversely, when the symbol used to calculate the vector sum correlation value is not the last symbol, the correlation apparatus may repeat operations S609 and S605 of selecting a next symbol and calculating a vector sum correlation value with respect to the selected symbol.

Hereinafter, a synchronization performance comparison will be made to verify that the magnitude sum correlation method and the vector sum correlation method according to the present invention have a further enhanced synchronization performance than an existing correlation method.

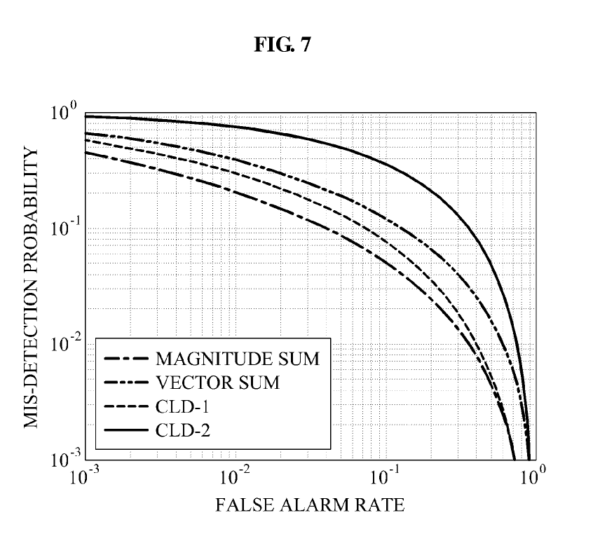

In all the tests corresponding to FIGS. 7 through 10, N=26 that is a number of SoFs of a DVB-S2 system is applied. When |Δ·T|≦fₘₐₓ, Δf generates a correlation value according to each of methods, that is, the magnitude sum correlation method, the vector sum correlation method, CLD-1, and CLD-2, in a uniform distribution in the range of [−fₘₐₓ, +fₘₐₓ]. Also, when fₘₐₓ=0, 0.05, 0.1, 0.15, 0.2, D=25, 9, 5, 3, 2 is used for a parameter of the vector sum correlation method, respectively.

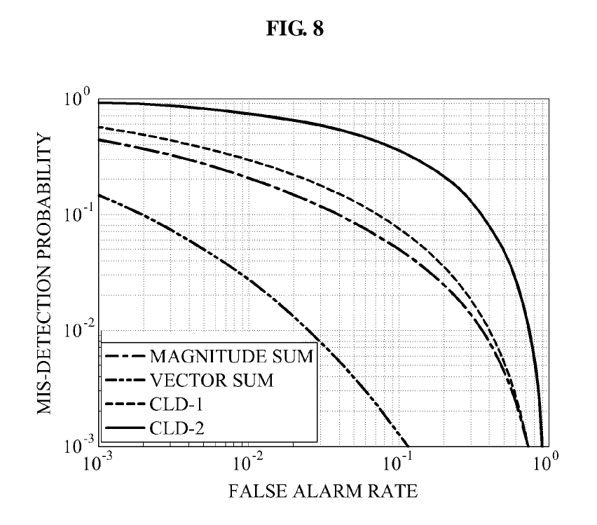

FIGS. 7 and 8 are graphs illustrating a synchronization performance comparison between CLD-1 and CLD-2 with a most excellent synchronization performance in the conventional art, and a vector sum correlation method and a vector sum correlation method according to an embodiment of the present invention, using a receiver operation characteristic (ROC), depending on whether a frequency error exists. Specifically, FIG. 7 is a graph illustrating a synchronization performance of a mis-detection probability (MDP) for each correlation method, when an SNR is −2.35 dB and fₘₐₓ=0.2. FIG. 8 is a graph illustrating the synchronization performance of the MDP for each correlation method, when the SNR is −2.35 dB and fₘₐₓ=0.

Referring to FIG. 7, the MDP of the magnitude sum correlation method according to an exemplary embodiment of the present invention is less than other MDPs of the other correlation methods, that is, the vector sum correlation method, CLD-1, and CLD-2. Accordingly, it can be known that the magnitude sum correlation method shows a further enhanced synchronization performance than the existing correlation methods in an environment where a great frequency error exists.

Referring to FIG. 8, the MDP of the vector sum correlation method according to an embodiment of the present invention is significantly less than the other MDPs of the other correlation methods, that is, the magnitude sum correlation method, CLD-1, and CLD-2. Accordingly, it can be known that the vector sum correlation method has the most excellent synchronization performance in an environment where the frequency error does not exist.

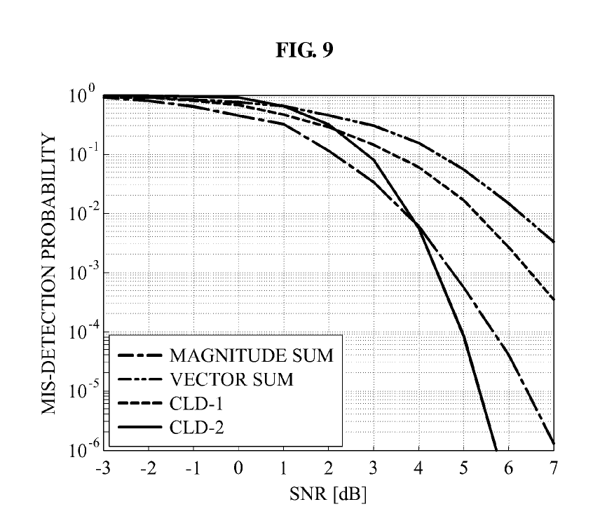

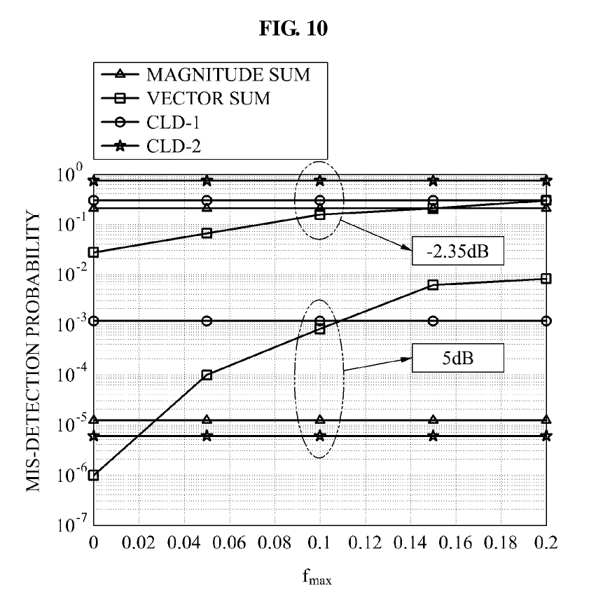

In order to fixed-quantitatively compare a synchronization performance for each correlation method using an ROC in FIGS. 7 and 8, in tests corresponding to FIGS. 9 and 10, a synchronization performance of an MDP is evaluated after fixing a FAR at a certain value. Through the tests, it can be known that the magnitude sum correlation method and the vector sum correlation method according to an exemplary embodiment of the present invention shows an SNR and frequency error section with a relatively excellent synchronization performance in comparison to the existing correlation methods, that is, CLD-1 and CLD-2.

FIG. 9 is a graph illustrating a synchronization performance comparison for each correlation method based on an SNR using a constant false alarm rate (CFAR) according to an embodiment of the present invention. Here, fₘₐₓ=0.2 is applied. A false alarm rate is fixed to 10⁻⁵ in an ROC performance curve, and then an MDP corresponding thereto is compared.

Referring to FIG. 9, wherein the SNR is less than about 4 dB, the MDP of the magnitude sum correlation method according to an embodiment of the present invention is less than the other MDPs of the other correlation methods, that is, the vector sum correlation method, CLD-1, and CLD-2. Accordingly, when the SNR is less than about 4 dB, the magnitude sum correlation method may have the most excellent synchronization performance in comparison to the existing correlation methods, that is, vector sum correlation method, CLD-1 and CLD-2.

FIG. 10 is a graph illustrating a synchronization performance comparison based on a change of fₘₐₓ in −2.35 dB SNR and 5 dB SNR according to an embodiment of the present invention. Here, a false alarm rate is fixed to 10⁻² in −2.35 dB SNR and the false alarm rate is fixed to 10⁻⁴ in 5 dB SNR.

Referring to FIG. 10, it can be verified that the MDP of the vector sum correlation method is relatively low in the range where fₘₐₓ<0.14 in −2.5 dB SNR, and in the range where fₘₐₓ<0.02 in 5 dB SNR. Through this, it can be known that the vector sum correlation method shows the most excellent synchronization performance. In particular, when a frequency error does not exist, MDPs of CLD-1 and CLD-2 are about 0.31 and about 0.72, respectively, in −2.35 dB SNR, whereas the MDP of the vector sum correlation method is about 0.03. Specifically, a synchronization performance is enhanced. Also, when the frequency error does not exist, MDPs of CLD-1 and CLD-2 are 1.2×10⁻³ and 6.0×10⁻⁶, respectively, in 5 dB SNR, whereas the MDP of the vector sum correlation method is 1.1×10⁻⁶. Specifically, a synchronization performance is enhanced.

As described above, a correlation method for acquiring a robust synchronization according to an embodiment of the present invention may enhance a frequency error in a low SNR using a magnitude sum correlation method and a vector sum correlation method and thereby may improve a synchronization performance.

The correlation method for acquiring the robust synchronization according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A correlation apparatus comprising:
a received symbol phase difference calculation unit to calculate a received symbol phase difference between a received symbol and a delay received symbol of delaying the received symbol;
a correlation Start of frame (SoF) symbol phase difference calculation unit to calculate a correlation SoF symbol phase difference between a correlation SoF symbol for a correlation and a delay correlation SoF symbol of delaying the correlation SoF symbol;
a differential correlation unit to calculate a differential correlation value of the received symbol using the received symbol phase difference and the correlation SoF symbol phase difference;
a Euclidean distance calculation unit to calculate a Euclidean distance value of the received symbol using the received symbol phase difference; and
a sum correlation unit to calculate a sum correlation value of the received symbol using the differential correlation value and the Euclidean distance value.

2. The correlation apparatus of claim 1, wherein the differential correlation unit comprises:
a multiplication unit to output a first phase difference multiplication value by multiplying the received symbol phase difference and the correlation SoF symbol phase difference, and to output a second phase difference multiplication value by multiplying a second received symbol phase difference between a second received symbol that is positioned next to the received symbol, and a second delay received symbol of delaying the second received symbol, and a second correlation SoF symbol phase difference between a second correlation SoF symbol that is positioned next to the correlation SoF symbol, and a second delay correlation SoF symbol of delaying the second correlation SoF symbol;
a summation unit to output a sum of phase difference multiplication values by adding up the first phase difference multiplication value and the second phase difference multiplication value; and
an absolute value processing unit to output the differential correlation value by calculating an absolute value with respect to the sum of phase difference multiplication values.

3. The correlation apparatus of claim 2, wherein the Euclidean distance calculation unit comprises:
a squaring unit to output a first square value by squaring the first received symbol phase difference and to output a second square value by squaring the second received symbol phase difference;
a summation unit to output a sum of square values by adding up the first square value and the second square value; and
a square root processing unit to output the Euclidean distance value by calculating a square root with respect to the sum of square values.

4. A correlation method comprising:
calculating a received symbol phase difference with respect to a received symbol;
calculating a correlation SoF symbol phase difference with respect to a correlation SoF symbol for a correlation;
calculating a differential correlation value of the received symbol using the received symbol phase difference and the correlation SoF symbol phase difference;
calculating a Euclidean distance value of the received symbol using the received symbol phase difference; and
calculating a sum correlation value of the received symbol using the differential correlation value and the Euclidean distance value.

5. The correlation value of claim 4, wherein the calculating of the differential correlation value comprises:
outputting a first phase difference multiplication value by multiplying a first received symbol phase difference with respect to a first received symbol of the received symbol and a first correlation SoF symbol phase difference with respect to a first correlation SoF symbol of the correlation SoF symbol, and outputting a second phase difference multiplication value by multiplying a second received symbol phase difference with respect to a second received symbol of the received symbol and a second correlation SoF symbol phase difference with respect to a second correlation SoF symbol of the correlation SoF symbol;
outputting a sum of phase difference multiplication values by adding up the first phase difference multiplication value and the second phase difference multiplication value; and
outputting the differential correlation value by calculating an absolute value with respect to the sum of phase difference multiplication values.

6. The correlation method of claim 5, wherein the calculating of the Euclidean distance value comprises:
outputting a first square value by squaring the first received symbol phase difference and a second square value by squaring the second received symbol phase difference;
outputting a sum of square values by adding up the first square value and the second square value; and
outputting the Euclidean distance value by calculating a square root with respect to the sum of square values.
